(19) United States
(12) Patent Application Publication
(10) Pub. No.: US 2014/0119004 A1
(43) Pub. Date: May 1, 2014

(54) Lighting Apparatus

(71) Applicant: Qing Yuan, Brisbane (AU)

(72) Inventor: Qing Yuan, Brisbane (AU)

(21) Appl. No.: 14/040,681

(22) Filed: Sep. 29, 2013

(30) Foreign Application Priority Data
Oct. 31, 2012 (AU) 201210625

(51) Int. Cl. F21V 15/01; F21K 99/00

(52) U.S. Cl. CPC F21V 15/012; F21K 99/00
USPC 362/231; 362/249.08

(57) ABSTRACT

A lighting apparatus including an at least semi-flexible elongate housing, wherein the housing includes an at least partially optically transparent portion and at least one lighting strip provided in the housing, the at least one lighting strip including a plurality of light emitting elements spaced thereon, the light emitting elements being for emitting light through the optically transparent portion, the light emitting elements being for emitting light of at least two different colours.

### BACKGROUND OF THE INVENTION

The present invention relates to a lighting apparatus, which in one example is suitable for use while engaging in outdoor activities such as camping, boating, fishing, or the like.

### DESCRIPTION OF THE PRIOR ART

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

Lighting apparatus for use while engaging in outdoor activities, such as camping, boating or fishing, are known and can include torches, lanterns, or the like. In particular, these apparatus suffer from a number of drawbacks, such as fragility or lack of robustness, they are awkward to attach to unconventional articles, such as a tree, boat railing, or similar, and they require specialist power/fuel sources, such as kerosene, expensive batteries, gas, or the like.

### SUMMARY OF THE PRESENT INVENTION

The present invention seeks to ameliorate one or more of the problems associated with the prior art.

In a first broad form the present invention seeks to provide a lighting apparatus, the apparatus including:
a) an at least semi-flexible elongate housing, wherein the housing includes an at least partially optically transparent portion; and,
b) at least one lighting strip provided in the housing, the at least one lighting strip including a plurality of light emitting elements spaced thereon, the light emitting elements being for emitting light through the optically transparent portion, the light emitting elements being for emitting light of at least two different colours.

Typically the apparatus is for emitting one or both of first and second colours including white and amber.

In a second broad form the present invention seeks to provide a lighting apparatus, the apparatus including:
a) an at least semi-flexible elongate housing, wherein the housing includes an at least partially optically transparent portion;
b) at least one lighting strip provided in the housing, the at least one lighting strip including a plurality of light emitting elements spaced thereon, the light emitting elements being for emitting light through the optically transparent portion; and,
c) at least one dimming mechanism, wherein in use the dimming mechanism allows a user to control an intensity of the light over a continuous intensity range.

Typically the apparatus includes an attachment mechanism provided on the housing, the attachment mechanism for attaching the apparatus to an article.

Typically the apparatus includes at least one of:
a) a connector, wherein in use the connector enables the apparatus to be coupled to a power source; and,
b) one or more controllers for selectively controlling the light emitted by the light emitting elements.

### BRIEF DESCRIPTION OF THE DRAWINGS

An example of the present invention will now be described with reference to the accompanying drawings, in which:

FIG. 1 is a schematic diagram of a first example of a lighting apparatus;

FIGS. 2A, 2B, and 2C are schematic diagrams of second, third and fourth examples of a lighting apparatus; and,

FIG. 3 is a schematic diagram of a fifth example of a lighting apparatus.

### DETAILED DESCRIPTION OF THE PREFERRED EMBODIMENTS

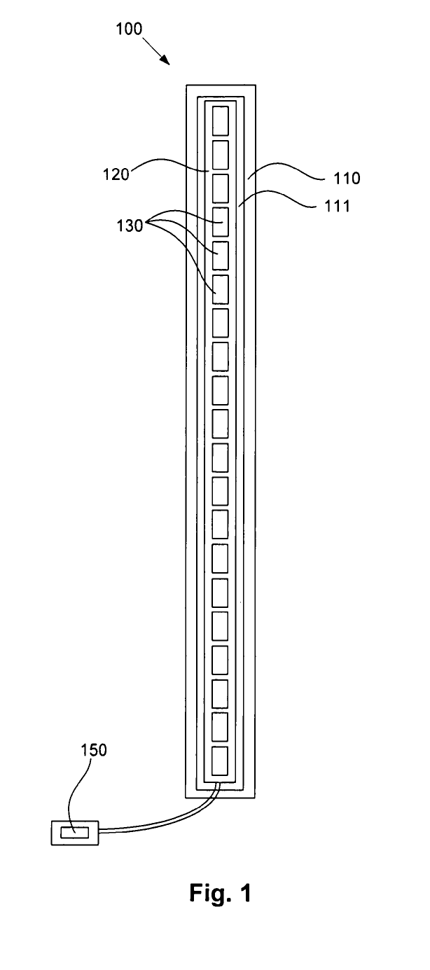

An example of a lighting apparatus will now be described with reference to FIG. 1.

In this example, the apparatus 100 includes an at least semi-flexible elongate housing 110, the housing 110 including an at least partially optically transparent portion 111. The apparatus 100 further includes one or more lighting strips 120 (with one being shown for the purpose of illustration) provided in the housing 110, the lighting strips 120 including one or more light emitting elements 130 arranged so that in use light can be transmitted through the transparent portion 111 of the housing 110, and thereby emitted from the apparatus 100 to provide illumination.

In one example, the light emitting elements 120 are for emitting light of at least two different colours. This can be achieved in any suitable manner depending on the preferred implementation. In one example, this can include providing two different types of light emitting element 120, each of which is adapted to emit light of a respective colour. Alternatively, this could be achieved using one type of light emitting element 120 that can emit light of different colours, for example, a bi- or tri-colour LED, or OLED, or the like.

In either case, the first and second colours can be of any suitable combination and allow different lighting combinations to be provided, for example for use in different situations. For example, the apparatus 100 could be adapted to selectively emit first and second colours such as white and amber, allowing the user to select either white light, which may be used in circumstances requiring high visibility, such as reading, or amber light, which may typically be used for more ambient lighting. It will further be appreciated, that amber light additionally offers significant advantages in an outdoor context, for example it does not attract insects, which are disruptive during outdoor pursuits, and can carry harmful and potentially fatal diseases such as dengue fever and malaria.

However, restriction to white and amber lighting is only one example, and alternative or additional colour combinations may be provided. For example, available colours may include red as red lighting typically allows for preservation of night vision, and thus may be useful in situations in which night vision is required, for example in attempting to observe nocturnal wildlife, celestial objects (eg. astronomy), or the like.

In another example, the apparatus 100 can include one or more dimming mechanisms 150, which allows a user to control an intensity of light emitted over a continuous intensity range. This arrangement provides apparatus 100 for use in lighting that can be utilised to illuminate an area to any desired intensity of light within the continuous intensity range. It will be appreciated that this feature provides the advantages of increased flexibility and utility, for example in being able to use the apparatus 100 for reading or cooking, which typically requires high intensity light, ambient lighting, which typically requires low intensity light, and any intensity therebetween for a multitude of other activities.

It will also be appreciated that the above described arrangements can be used independently or in conjunction. For example, it may be desirable to be able to control the intensity of white light emitted from the apparatus 100, whilst further being able to select one or more different colours as required.

A number of further features that can be implemented in the above described arrangements will now be described.

The housing 110 and optically transparent portion 111 may be made of any suitable flexible or semi-flexible materials, such as impregnated woven fabrics, plastics, or the like, depending on the preferred implementation. In one example, the housing 110 is arranged to provide a protective barrier around the lighting strip 120, such as by ensuring the housing 110 is dust proof and/or weather resistant, such as water resistant, water proof, or the like. It will be appreciated that this enables the apparatus 100 to be used during outdoor pursuits, and in all types of weather, without fear of the apparatus 100 becoming damaged, defective, or harming a user, for example via an electric shock during wet weather.

Furthermore, the housing 110 may provide at least partial protection from impacts, and in this regard may include a shock absorbent padding, such as foam, silicon, or the like. It will be appreciated that this would increase the durability of the apparatus 100, thereby increasing its reliability, especially when used for outdoor or sporting activities, although this is not essential.

Additionally or alternatively, the housing 110 may be provided sealed or openable and/or re-sealable. In this respect, a re-sealable housing 110 allows the user to remove, replace, and/or interchange one or more lighting strips 120. For example, if a lighting strip breaks or becomes defective, it can be replaced or repaired without having to also replace the housing 110. Additionally, lighting strips 120 can be added, removed or interchanged to provide different colour combinations, depending upon the activities being undertaken.

The lighting strip 120 can also be of any suitable form. In one example, the lighting strip 120 includes a substrate, which may be composed of any suitable material, such as plastic or the like, and which supports the light emitting elements 130 and any other required componentry. This can include one or more conductive tracks for supplying power to the light emitting elements, and optionally one or more inbuilt components, such as resistors, capacitors, or the like, which may be used for ensuring correct operation of the light emitting elements 130.

Additionally, the lighting strip 120 may be at least semi-flexible. It will be appreciated that this may be achieved by including in the lighting strip 120 a wholly flexible substrate with the conductive tracks, components, and light emitting elements provided thereon. Alternatively, the lighting strip 120 may include a number of discrete, rigid substrates interconnected by flexible connectors, thus forming an at least semi-flexible lighting strip 120. However, this feature is not essential.

The use of a flexible substrate and at least semi-flexible housing 110 can be particularly beneficial however as these can allow the apparatus 100 to adapt to any surroundings in which it is provided. For example, the apparatus 100 may be provided encircling an object such as a tree, or provided along two faces of an article that are at disparate angles such as faces of a tent, or hanging in an arcuate manner between two points. In this respect, the apparatus 100 may also be provided in a compact manner during storage, for example by rolling up the housing 110. It will be appreciated that this enables the footprint of the apparatus 100 to be substantially reduced for storage or transport, thus saving space. Furthermore, the at least semi-flexible housing 110 is more resilient to breakage, as it is able to easily conform to particular shapes and situations, unlike, for example, traditional fluorescent tubes, lanterns, or similar, which include glass or other fragile and breakable elements.

Whilst the light emitting elements 130 can be of any suitable form, in one example, the light emitting elements 130 are in the form of Light Emitting Diodes (LEDs). It will be appreciated that LEDs provide advantages such as low power consumption, a long lifetime, and thus do not require replacing as frequently, robustness, are small in size, and offer fast switching. However, this feature is not essential, and the light emitting elements may include any suitable elements, including incandescent light elements, fluorescent or neon light elements, organic light emitting diode (OLED), electroluminescent (EL) elements, liquid crystals, or the like.

The nature of the dimming mechanism 150 will vary depending on the preferred implementation and the nature of the lighting elements 130. For example, in the event that the lighting elements are LEDs, the dimming mechanism will typically include an LED driver with suitable dimming capability, such as the ability to reduce/increase the current applied to the LEDs, provide for digitally controlled pulse width modulation (PWM) of the supply current, or the like. However, this is not essential, and it will be appreciated that any suitable dimming mechanism 150 may be used depending on the light emitting elements 130, for example a variable resistor may be used with an incandescent light element.

The dimming mechanism 150 may be of any suitable form depending on the preferred implementation. For example, the dimming mechanism 150 includes a small rotatable dial or wheel, which can be rotated in order to select an intensity of light emitted from the continuous intensity range. Alternatively, the dimming mechanism can include a sliding dimmer or the like.

The apparatus 100 may also include one or more controllers for controlling the light emitted by the light emitting elements. The controllers may include the dimming mechanism described above, and may also include switches or other control mechanisms to allow control over other aspects of the light emitted from the apparatus 100. For example, switches may be used to selectively activate or deactivate the light emitting elements 130, including activating or deactivating different colours. Switches and the dimming mechanism may be co-located on a common housing, or may be integrated into a single component. For example, the dimming mechanism 150 could include a dial that can be rotated to control the intensity of white light emitting elements, whilst the dial could further define a pushbutton that is used to actuator the amber light emitting elements. Other arrangement could also be used.

Controllers may also be provided to allow the user to select no emission of light, continuous light emission, or flashing light emission, in either discrete or continuous increments, such as, a slow or fast flashing light emission, or alternatively allowing a user to select from a continuous range of flashing speeds.

It will be appreciated that in this respect the controller may be any suitable controller, for example one or more switches, or a microcontroller such as a microprocessor, a FPGA, or the like. It will further be appreciated that the microcontroller may be programmable, for example, to provide different control functionality, such as providing a sleep function which turns off the emission of light from the apparatus 100 after and/or at a predefined time, or a timer function which periodically alters the emission of light, for example switching the light from off to on, or from fast flashing to high intensity, or the like. In one example, the microcontroller may allow for user programmability, and in another example, the microcontroller may be programmed to predefined factory settings.

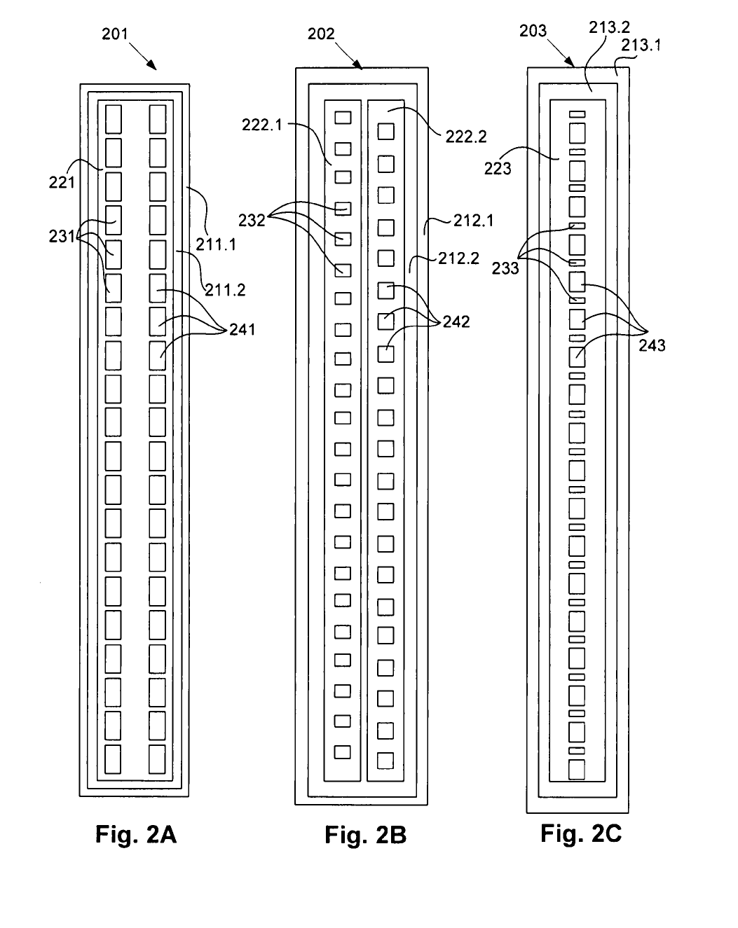

A number of further examples of a lighting apparatus 201, 202, 203 are shown in FIGS. 2A to 2C.

In the example of FIG. 2A, the apparatus 201 includes an at least semi-flexible elongate housing 211.1 having an at least partially optically transparent portion 211.2. The apparatus 201 further includes a lighting strip 221 including light emitting elements 231, 241 arranged in two laterally spaced rows, thereby allowing the apparatus 201 to provide parallel strips of illumination.

In one example, the light emitting elements 231, 241 can be adapted to emit respective colours of light, so that each strip of illumination is provided in a respective colour. However, other arrangements could be used, so that for example first and second light emitting elements 231, 241 can be interspersed along each strip. Additionally, the lighting strip 221 may optionally include further light emitting elements, allowing additional colours to be emitted. This may be particularly useful, for example, for parties and the like where it may be desirable to include a number of different of colours.

In use, the first and second light emitting elements 231, 241, may emit light either simultaneously, or at different times. It will be appreciated that the user may control the emission of light from the first light emitting elements 231, independently from the second light emitting elements 241, or alternatively may control both the first and second light emitting elements 231, 241 in conjunction. Additionally or alternatively, the apparatus 201 may include one or more controllers, allowing the different colours emitted to be controlled automatically, for example in accordance with a pre-programmed illumination pattern.

In a further example, shown in FIG. 2B, the apparatus 202 includes a housing 212.1 having an optically transparent portion 212.2 and two lighting strips 222.1, 222.2. In this example, a first lighting strip 222.1 including one or more first light emitting elements 232 that, in use, emit light of a first colour, and a second lighting strip 222.2 including one or more second light emitting element 242 that, in use, emit light of a second colour.

In this respect, it will be appreciated that the first and second light emitting elements 232, 242 may be the same, in which case the first and second colour is also the same. Alternatively, the first and second light emitting elements 232, 242, or the first and second colour is different. As in the previous example, a controller, such as suitable switches can be used for selectively activating each set of lighting emitting elements 232, 242 independently or in conjunction. In any event, the use of more than one lighting strip 222.1, 222.2 can increase reliability and robustness, for example, by adding some redundancy to the apparatus 202, as well as allowing each lighting strip to be replaced independently. This can allow lighting strips for emitting different colours to be interchanged as required, for example depending on the intended application, thereby increasing the flexibility of the apparatus.

In a further example, shown in FIG. 2C, the apparatus 203 includes a housing 213.1 having an optically transparent portion 213.2, and a lighting strip 223 including a plurality of first and second light emitting elements 233, 243, which therefore functions substantially as described above.

In this example, the first and second light emitting elements 233, 234 are substantially interleaved, however it will be appreciated from this that they may be arranged in any suitable manner including spaced apart in substantially parallel rows, randomly scattered, or the like. This example also shows relative sizes of the first and second light emitting elements 233, 234 are different, however this is not essential, and the sizes may be the same, or may varying uniformly, randomly, or the like.

It will be appreciated from the above examples that a wide variety of arrangements of lighting strip(s) and/or light emitting elements can be used, and the above described arrangements are for the purpose of illustration only and are not intended to be limiting.

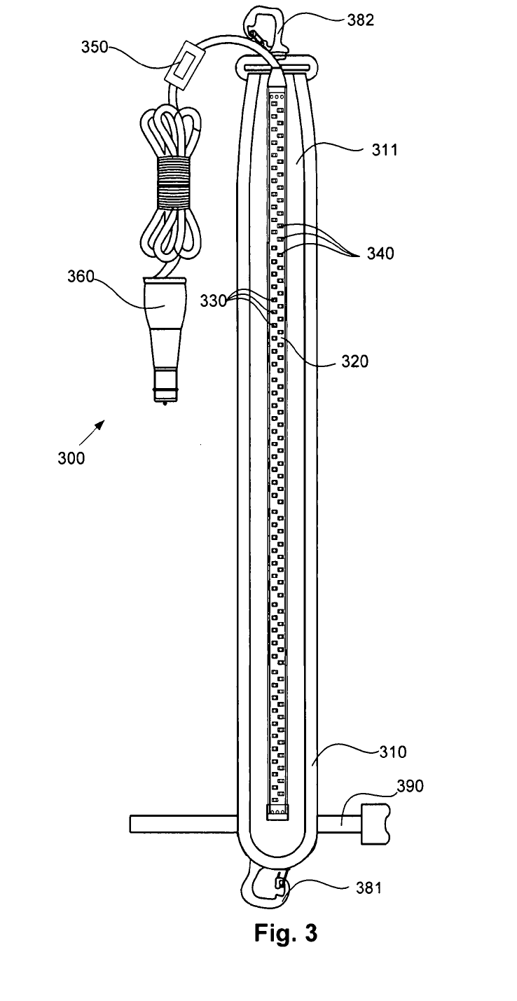

A fifth specific example 300 will now be described with reference to FIG. 3.

In this example, the apparatus 300 includes an at least semi-flexible elongate housing 310, including an optically transparent portion 311, and a single lighting strip 320 having a plurality of first and second LEDs 330, 340, mounted thereon. The apparatus 300 also includes at least one dimming mechanism 350, which includes a dial that allows a user to control an intensity of light emitted by the first LEDs 330. The dial also functions as a pushbutton switch for selectively activating the second LEDs 340. In one example, this allows the intensity of white light emitted to be progressively controlled, whilst light of an alternative colour, such as amber, can be switched between on and off, using a single actuator in the form of the dial 350.

The apparatus 300 also includes one or more attachment mechanisms for attaching the apparatus 300 to an article, for example, a tent pole, a boat railing, other camping furniture, or the like. In this example, the attachment mechanisms include two clips 381, 382 at opposing ends of the housing 310 that may be coupled to any suitable article. However, it will be appreciated, that any number of clips 381, 382 may be used, and that additionally the position of the clips 381, 382 may configurable in respect to a location on the housing 310, so as to suit a particular situation.

In one example, the attachment mechanism may additionally or alternatively include a reusable fastener, such as a reusable and/or regenerative adhesive, an adhesive tape, a hook and loop fastener, such as Velcro®, or the like. In this example, the reusable fastener includes a first portion provided on a face of the housing 310 (not shown), and a complementary second portion 390, provided on one or more detachable straps 390. This arrangement allows the apparatus 300 to be provided on or moulded around objects, or articles, such that when the first portion and second portion 390 are brought into abutment, the first portion, and thus the apparatus 300, is substantially secured to the second portion 390, and thus the object or article. In this respect, the reusable fastener provides significant advantages include allowing the apparatus 300 to be provided on or adjacent to irregular objects/articles, or objects/articles without appropriate or convenient hook-like or attachment elements.

In one example, the first portion is provided on an external (rearward) face of the housing opposing the transparent portion, and is composed of either hook or loop portions of hook and loop fasteners. The second portions include three complementary and detachable loop or hook portions of of hook and loop fasteners. This allows the three second portions to be arranged in any configuration, for example encircling objects, substantially flat and abutting objects, or the like, so that the apparatus can be attached to a variety of surfaces or objects, through suitable configuration of the hook and loop fasteners.

However, it will be appreciated that any number and type of attachment mechanism may be used, for example, ties, straps, cuffs, hooks, carabiners, or the like, and it will further be appreciated that this feature is optional.

A connector 360 is also included in the apparatus 300, which enables the apparatus 300 to be coupled to a power source. In this example, the connector corresponds to a car power supply connector, or car cigarette power supply connector. In this respect, the apparatus 300 has low power requirements and when coupled to a typical car or automotive battery power source can operate continuously for over 25 hours. It will be appreciated that in this regard, the apparatus 300 offers a low power solution, which is suitable for long periods of operation.

However, it will be appreciated that the power source may include any suitable source, for example a battery, including a car battery, mains power, a generator, a solar power source, or the like. Additionally or alternatively, the apparatus 300 may include an alternative power source, such as a battery, which may provide power to the apparatus 300 when the apparatus 300 is not connected to the power source and which additionally may be recharged by the power source when connected. However, this feature is not essential.

It will be appreciated that a lighting apparatus 100, 201, 202, 203, 300 with the above described examples, provides a flexible, durable and robust arrangement for use particularly in outdoor settings, and other settings which are typically devoid of lights.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described. Thus, for example, it will be appreciated that features from different examples above may be used interchangeably where appropriate.

1) A lighting apparatus, the apparatus including:
a) an at least semi-flexible elongate housing, wherein the housing includes an at least partially optically transparent portion; and,
b) at least one lighting strip provided in the housing, the at least one lighting strip including a plurality of light emitting elements spaced thereon, the light emitting elements being for emitting light through the optically transparent portion, the light emitting elements being for emitting light of at least two different colours.

2) An apparatus according to claim 1 wherein the apparatus is for emitting one or both of first and second colours including white and amber.

3) A lighting apparatus, the apparatus including:
a) an at least semi-flexible elongate housing, wherein the housing includes an at least partially optically transparent portion;
b) at least one lighting strip provided in the housing, the at least one lighting strip including a plurality of light emitting elements spaced thereon, the light emitting elements being for emitting light through the optically transparent portion; and,
c) at least one dimming mechanism, wherein in use the dimming mechanism allows a user to control an intensity of the light over a continuous intensity range.

4) An apparatus according to any one of the preceding claims, the apparatus including an attachment mechanism provided on the housing, the attachment mechanism for attaching the apparatus to an article.

5) An apparatus according to any one of the preceding claims, the apparatus including at least one of:
a) a connector, wherein in use the connector enables the apparatus to be coupled to a power source; and,
b) one or more controllers for selectively controlling the light emitted by the light emitting elements.
